(19) United States
(12) Patent Application Publication
(10) Pub. No.: US 2010/0215273 A1
(43) Pub. Date: Aug. 26, 2010

(54) METHODS AND DEVICES FOR CHARACTERIZING POLARIZATION OF ILLUMINATION SYSTEM

(75) Inventors: Yuri Aksenov, Leuven (BE); Peter Dirksen, Leuven (BE); Peter Zandbergen, Leuven (BE); Michael Benndorf, Leuven (BE); David Van Steenwinckle, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,063

(22) PCT Filed: Jun. 20, 2006
(86) PCT No.: PCT/IB06/51979

§ 371 Date: Dec. 19, 2007

(30) Foreign Application Priority Data
Jun. 24, 2005 (EP) 05105679.4

(51) Int. Cl. G06K 9/46

(52) U.S. Cl. 382/190

(57) ABSTRACT

In a method for evaluating the polarization state of an illumination system (52) in an optical system (50), a mask (56) is provided in the optical system (50) such that an illumination beam incident on the mask (56) is adapted such as to substantially differently diffract incident components of a light beam having different polarization states. An image of the mask (56) is then obtained, using an illumination beam of the illumination system (52) of the optical system (50). The obtained image, being either an intensity plot or a structure created in a resist layer by exposing the resist layer with the image of the mask (56), is then used to extract polarization related information about the illumination system (52). The image used for evaluating may be a diffraction image of the mask.

The present invention relates to the field of optical systems using polarized radiation, especially light. More particularly, the invention relates to a method and a device for characterizing the degree of polarization of illumination systems in such optical systems.

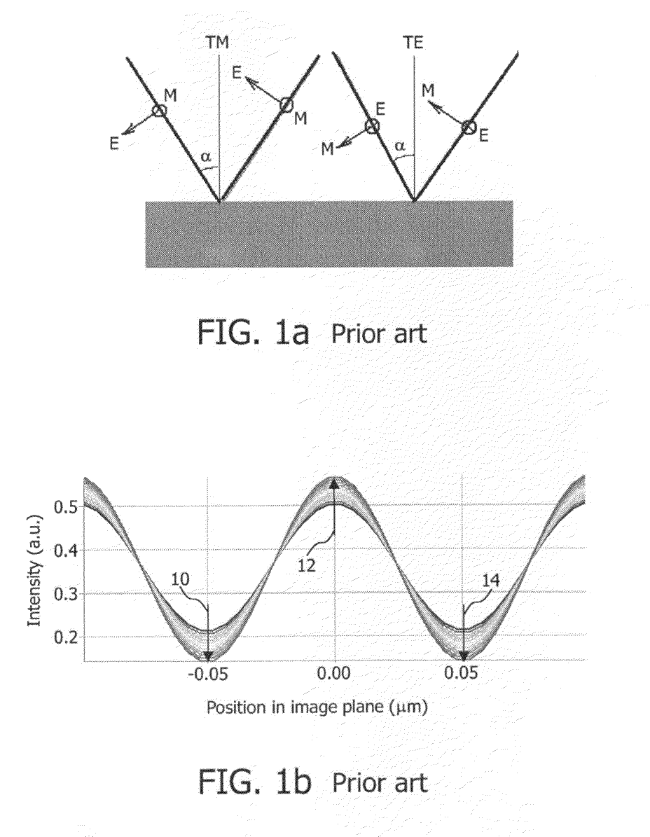

High numerical aperture (N.A.) lithographic systems are powerful tools for fabrication of electronic components meeting today's requirements of miniaturization. Unfortunately, several undesirable effects are encountered in case high N.A. systems are used. These effects give rise to distorted images, resulting in a lower quality of the electronic components made. The polarization state of radiation, e.g. light, typically can be split into a transversal electric (TE) polarization component and a transversal magnetic (TM) polarization component, as shown in FIG. 1a, whereby the polarization components are defined with reference to the plane of incidence, i.e. the plane on which the radiation, e.g. light, is incident, and with reference to the angle of incidence. Typical examples of such planes of incidence are the image plane or a refraction/reflection plane or a diffraction plane, such as e.g. the plane determined by the mask. A typical problem encountered with polarized radiation is that the contrast that can be produced by radiation, e.g. light, depends on the polarization state of the radiation. The latter is caused by differences in interference effects for different polarization states of radiation. For example for superposition of radiation having a TM polarization component, the resulting intensity depends on the angle under which the radiation interferes. The latter is illustrated in FIG. 1b, indicating the contrast in a latent image for light having no TE polarization component, for purely TE polarized light and for mixed light having both a TE and TM polarized component. For TM polarized light, at an angle of 90° between the two superposed radiation beams, no image is formed but only background is shown. The graphs in FIG. 1b illustrate the light intensity distribution in the image plane for light beams having an increasing amount of TE polarized light, indicated by the direction of the arrows 10, 12, 14 going from purely TM polarized radiation towards purely TE polarized radiation. As the angles of incidence are significantly larger in case of high N.A. lithography systems, e.g. in immersion lithography systems, this problem poses high quality demands on the lithographic system used, especially on the illumination system and the polarization state of the radiation, e.g. light, it produces. Consequently, it may be useful to check the quality of polarized illumination systems used in such optical systems

Only a few techniques exist for measuring and checking the polarization state of an illumination system in an optical system. In general, some basic techniques are known in optical science for checking the polarization state of an illumination beam. An often-used technique for testing the polarization state of an illumination beam is using an analyzer in the light path and measuring the relative light intensity passing the analyzer using a photo-detector. An analyzer physically is a polarizing means, i.e. an optical component transmitting a specific polarization state of the illumination beam, e.g. light. An analyzer thus may be an absorbing dichroic polarizer, a metal wire-grid polarizer or a multi-layer polarizer utilizing Brewster angle. Whereas the first two types operate with substantially normally incident light, a typical Brewster type polarizer has an operating angle of about 45°. In use, the position of the analyzer often needs to be adapted to the specific optical system. For example, if an analyzer is combined with a quartz rod, which acts as a homogenizing system, the analyzer needs to be installed in the illumination beam path, e.g. light path, before the quartz rod, as otherwise no information about the illumination source, e.g. light source, will be obtained. Nevertheless, the latter will not teach how the polarization degree is changed further due to propagation through the remaining part of the illumination beam, e.g. light path, towards the mask level, especially through the quartz rod where remaining birefringence is capable to change polarization state of incoming illumination beam, e.g. light. Nevertheless, the polarization state on the path of the illumination beam, e.g. light path, between the illumination source, e.g. light source, and the mask influences the quality of the final image obtained.

Another approach is to coat the upper surface of the mask with a dichroic or wire-grid type of polarizer and to image a certain pattern with radiation, e.g. light, having only a selected polarization component. By comparison between an unpolarized image, obtained using a mask without mask top coating, and the polarized image, obtained with the coated mask, the degree of polarization for radiation, e.g. light, at the mask level can be extracted. However, wire-grid polarizers usually are made of sub-wavelength features by lithographical techniques. It is to be noted that high efficiency wire-grid polarizers for 193 nm wavelength need to be made by high resolution electron beam lithography (˜15-20 nm pitch), which results in a high-cost device, both economically and in time. Although a chemical way of producing a wire grid polarizer may be available, the quality and performance of polarizers thus obtained is far from ideal. A problem related to the use of dichroic polarizers is the low efficiency and transmittance at 193 nm. Alternatively, Brewster type of multi-layer polarizing coatings cannot be used as a mask top layer coating for polarization detection purposes, as these are only operable under an angle of 45 degrees. Most of the commercial systems currently available for higher wavelength ranges have a characteristic performance that drops fast into the deep UV region.

U.S. Pat. No. 6,784,992 describes a method and device for determining a polarization state of light in an optical system. The method is based on providing a single first light ray of an illumination beam through a first point of an opaque frame, resulting in illumination of a first point in a photoresist. The corresponding light ray has a known angle of incidence. A single second light ray of an illumination beam is provided through a second point of an opaque frame, resulting in illumination of a second point in a photoresist. The second light ray also has a known angle of incidence. From the angles of incidence and the amount of light absorbed in the photoresist for each light ray, it is possible to determine the polarization state of the illumination system.

None of the above methods or devices results in an efficient way of evaluating the polarization state of radiation provided by an illumination system.

It is an object of the present invention to provide methods and systems for evaluating the polarization state of an illumination system in an optical system.

The above objective is accomplished by a method and device according to the present invention.

The present invention relates to a method for evaluating an illumination system in an optical system, the method comprising: providing a mask in the optical system, the mask being adapted so as to diffract in a substantially different way incident components of an illumination beam having a different polarization state, obtaining an image of the mask using an illumination beam of the illumination system incident on the mask, and evaluating the image to extract polarization related information about the illumination system. To diffract in a substantially different way incident components having a different polarization state thereby may mean that incident components having a different polarization state are diffracted into diffracted components being significantly different, e.g. having a significantly different diffracted intensity. In other words, the mask may be adapted to create different diffraction effects for differently polarized components of the illumination beam. Thus, in contrast to wire grid masks, the masks according to embodiments of the present invention allow to substantially diffract the beam towards a projection lens pupil of the system, e.g. diffracting a first order beam component on a projection lens pupil of the system.

The mask being adapted so as to diffract in a substantially different way incident components of an illumination beam having a different polarization state may comprise the mask being adapted to generate in a substantially different way zero and first order diffraction beams of incident components of an illumination beam having a different polarization state. It is an advantage of the present invention that the method may allow to obtain information about the polarization degree of the illuminating system used and that there is no overlap with polarization effects induced by the lens. It thus is an advantage of embodiments of the present invention that the method allows to extract both information about the polarization state at the mask level, i.e. polarization effects induced in the illumination system, and information about the polarization changes occurring in the projection lens, independently, in a single experiment. The mask may be an attenuated phase shift mask. It is an advantage that the masks used in the method may be made using standard techniques and that they can be made using standard materials. Diffracting in a substantially different way incident components of an illumination beam having a different polarization state may comprise differently suppressing a zero order diffraction of the incident components. It is an advantage of the present invention that method work for normal operation conditions of the optical system, without an extra equipment. It is an advantage of the present invention that the obtained information may be based not merely on the polarization state, thus allowing to distinguish from other polarization effects. The method of the present invention may allow to obtain first order diffraction beams stemming from the different incident components of the illumination beam at the projection lens pupil.

Evaluating may comprise obtaining a degree of polarization for the illumination system. It is an advantage that polarization information of the illumination system itself may be obtained, i.e. that polarization information is obtained for the illumination system used for illuminating the mask. It is also an advantage that a well-known physical quantity for polarization may be obtained.

Evaluating may comprise comparing light intensities in an image plane. It is an advantage of embodiments of the present invention that a simple and fast technique is obtained for evaluating the polarization state of an illumination system. Evaluating the image may comprise extracting feature sizes from the image. Evaluating the image, the image comprising a plurality of features, may comprise extracting intensity differences between neighboring features.

With λ being the average wavelength of the illumination beam of the illumination system and with the mask comprising a pattern with features characterized by an average feature size and an average pitch size, the mask may be adapted by selecting an average feature size to be in a range between 0.2λ and 4λ, preferably between λ and 3λ. The mask may be adapted by selecting an average pitch size to be in a range between 0.2λ and 6λ, preferably between λ and 5λ.

The mask may comprise a pattern with a plurality of features in order to obtain a confined diffraction of the illumination beam. It is an advantage that a high accuracy can be obtained with a method according to embodiments of the present invention.

The mask may comprise a plurality of areas having a first feature density separated by areas with a second feature density, the first feature density being different from the second feature density. The second feature density may be zero, in other words no features may be present in areas with a second feature density. It is an advantage that the patterns might be placed onto free area of a production mask (reticle) without a need to order separate mask to conduct the polarization test. It is an advantage that the method and systems of the present invention can be used to evaluate off-axis illumination systems.

Obtaining an image of the mask may comprise illuminating a resist layer with a pattern of the mask or a negative image thereof and developing the resist layer. It is an advantage that the method may allow to obtain a sufficient degree of accuracy.

Obtaining an image of the mask may comprise measuring or registering the light intensity in an image plane for the illumination beam. It is an advantage of certain embodiments of the present invention that no resist model may be needed for obtaining polarization related information.

Obtaining an image of the mask may comprise obtaining a diffraction image of the mask. It is an advantage of particular embodiments of the present invention that an easy interpretation of the obtained images may be obtained, allowing to directly derive polarization information from the obtained image.

Evaluating the image may comprise evaluating a predetermined diffraction order in the diffraction image. Evaluating the image may comprise evaluating the zero diffraction order in the diffraction image. It is an advantage of particular embodiments of the present invention that no complicated image formation model is required, e.g. also not when systems with large sigma values are evaluated. It is also an advantage of particular embodiments of the present invention that a simple detector can be used.

Evaluating a predetermined diffraction order, e.g. the zero diffraction order, in the diffraction image may comprise evaluating a parameter, e.g. the intensity, of the predetermined diffraction order, e.g. zero diffraction order, as function of an orientation of a test pattern provided on the mask. It is advantageous in particular embodiments of the present invention that only the intensity of the zero diffraction order needs to be evaluated as function of a test pattern orientation on the mask

Obtaining an image of the mask using an illumination beam of the illumination system incident on the mask may comprise blocking at least part of an illumination of the illumination system, such that the illumination beam is equivalent to an illumination beam of a monopole or dipole illumination system. It is an advantage of particular embodiments of the present invention that multi-pole illumination systems, such as e.g. annular illumination systems and illumination systems having more than two poles, such as e.g. quadrupole illumination systems, can be evaluated in an easy and user-friendly way.

Providing a mask furthermore may comprise providing a filter for blocking at least part of an illumination of the illumination system.

It is an advantage of particular embodiments of the present invention that evaluating of multi-pole illumination systems can be done in an easy and user-friendly way without the need for adapting the optical system substantially.

Evaluating the image to extract polarization related information about the illumination system may comprise evaluating dose-to-clear information.

It is an advantage of particular embodiments of the present invention that the degree of polarization can be easily calculated. It furthermore is an advantage of particular embodiments of the present invention that a highly sensitive technique for evaluating polarization of an illumination system is obtained, thus allowing to identify small changes in the polarization of an illumination system.

The invention furthermore relates to a test kit for testing an illumination system in an optical system, the test kit comprising a mask adapted so as to diffract in a substantially different way incident components of an illumination beam having a different polarization state.

The test kit may furthermore comprise a detector adapted for recording an image of the mask in an image plane of the optical system. The test kit furthermore or alternatively may comprising a substrate covered with a resist layer adapted for being illuminated with an image of the mask in an image plane of the optical system.

The invention also relates to an optical system, the optical system comprising an illumination system and a detector, whereby the detector is adapted for being positioned at an image plane of the optical system and furthermore is adapted for recording an image of a mask diffracting in a substantially different way incident components of a light beam of the illumination system having a different polarization state, the optical system furthermore comprising a computing means for evaluating the image to extract polarization related information about the illumination system. The optical system furthermore may comprise a substrate stage, whereby the detector is positioned at or incorporated in the substrate stage. The test kit furthermore may include a feedback system that automatically corrects a polarization state of illumination according to the measured data and without the need of a user. A polarization state can be corrected by implementing a compensating optical or electro-optical element that can be externally controlled or by correcting the properties of the optical elements already presented in the light path.

The optical system furthermore may comprise a processed wafer, whereby said detector is incorporated in said processed wafer. It is an advantage of particular embodiments of the present invention that use of a sensor-wafer, e.g. a processed wafer with integrated detector, in combination with the special mask allows to tool-independently conduct polarization tests and to compare them, free of tool equipment specific errors.

The invention also relates to a method for deriving a polarization state of an illumination system in an optical system, the method comprising obtaining related information of an image of a mask adapted so as to diffract in a substantially different way incident components of an illumination beam having a different polarization state, processing the related information in order to obtain data related to the incident components of an illumination beam having a different polarization state, and deriving from the obtained data polarization related information about the illumination system. The polarization related information may be a degree of polarization. The image of a mask may comprise a print of a mask in a resist layer and the related information of an image of a mask may be one or more scanning electron microscope pictures.

The invention also relates to a computer program product for executing any of the methods according to embodiments of the present invention or part thereof. The invention furthermore relates to a machine readable data storage device for storing such a computer program product and to the transmission of such a computer program product over a local or wide area telecommunications network.

Particular and preferred aspects of the invention are set out in the accompanying independent and dependent claims. Features from the dependent claims may be combined with features of the independent claims and with features of other dependent claims as appropriate and not merely as explicitly set out in the claims.

It is an advantage of the present invention that the numerical aperture of the optical system studied does not limit the method.

It is furthermore an advantage of the present invention that production of the mask used can be based on existing technologies and that the mask can be made of conventional materials known for mask production.

It is an advantage of embodiments of the present invention that the degree of polarization is obtained based on different zero order suppression of the two polarization components.

It is also an advantage of the embodiments of the present invention that they allow simple and fast analyses of the experimental data obtained during application of the method. It is an advantage of the embodiments of the present invention that they provide an efficient method for evaluating an illumination system.

The teachings of the present invention permit the design of improved methods and apparatus for checking and/or evaluating the quality of an illumination system in an optical system.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1a illustrates the TM and TE polarization components in a light beam with reference to the plane of incidence, as known from prior art.

FIG. 1b illustrates the intensity distribution of light in an image plane of an optical system for differently polarized light beams, as known from prior art.

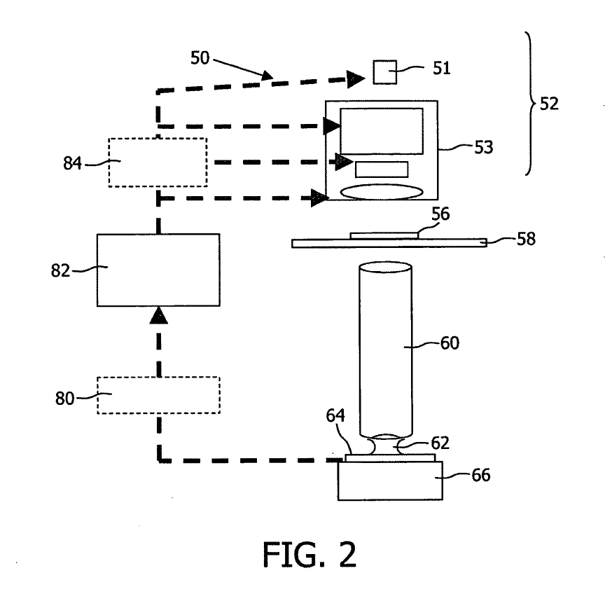

FIG. 2 is an exemplary optical system wherein the method according to a first embodiment of the present invention can be applied.

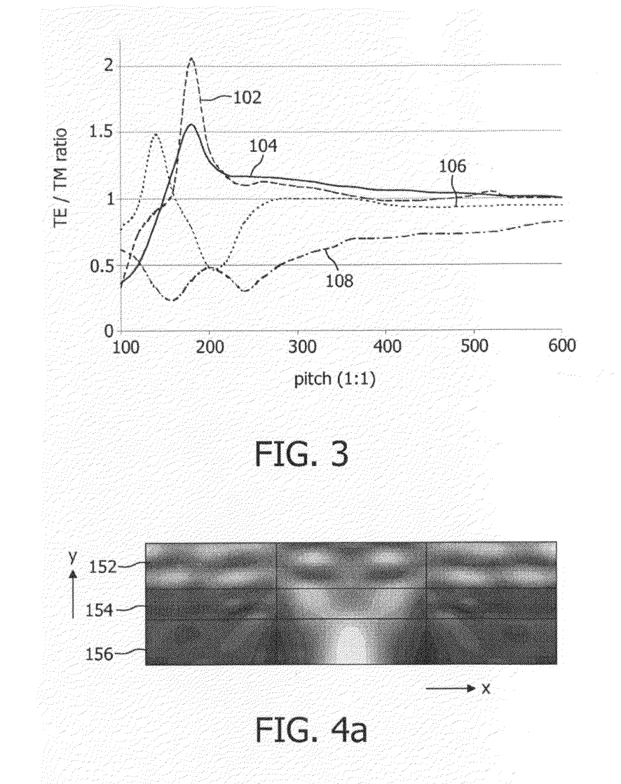

FIG. 3 is a graph indicating TE polarization/TM polarization ratio after diffraction as a function of the pitch in a mask for different types of masks, as can be used according to embodiments of the present invention.

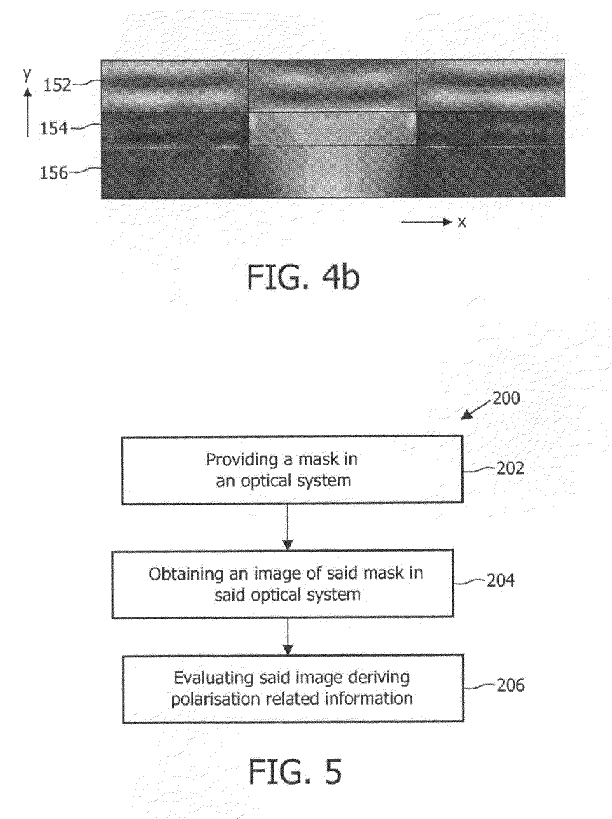

FIG. 4a and FIG. 4b illustrated the diffracted field at an attenuated phase shift mask for TE polarized light respectively TM polarized light, as can be used according to embodiments of the present invention.

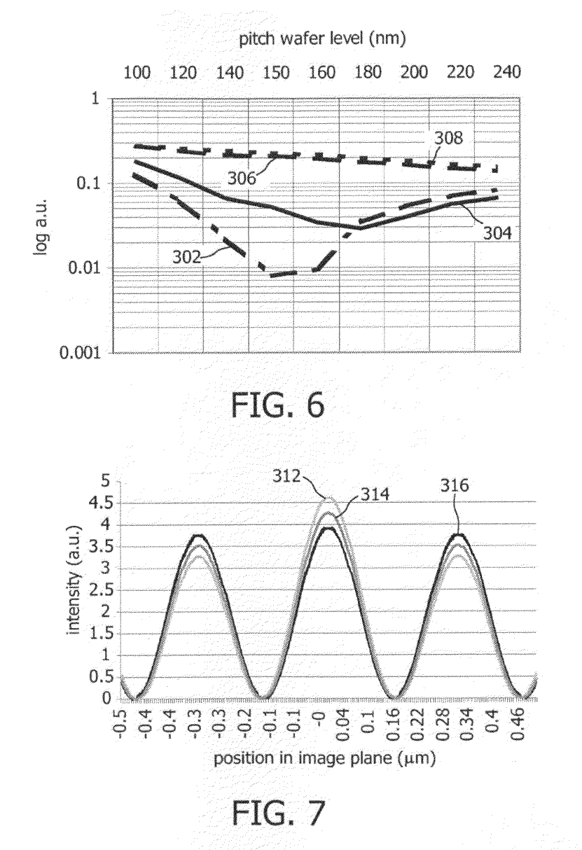

FIG. 5 is a flow diagram of a method for checking and/or evaluating the polarization state of an illumination system of an optical system according to a first embodiment of the present invention.

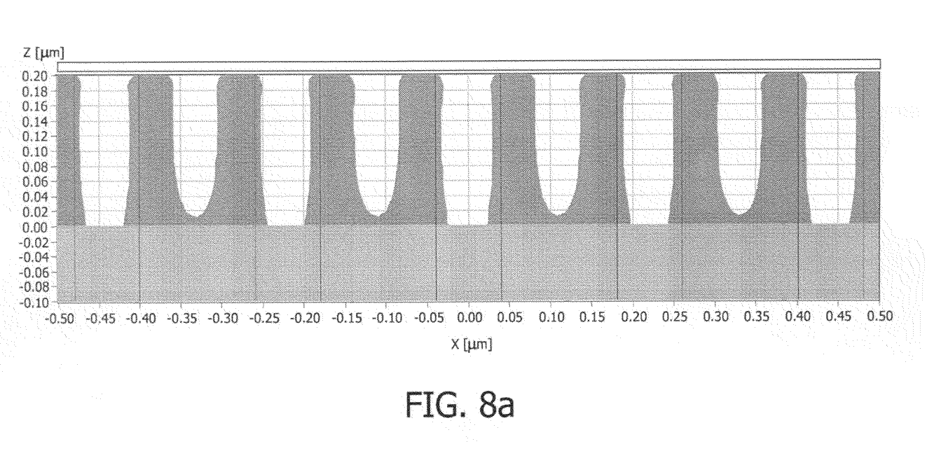

FIG. 6 is a graph illustrating the diffraction efficiency for zeroth and first order diffraction of a TE and a TM polarized illumination beam, as can be used according to embodiments of the present invention.

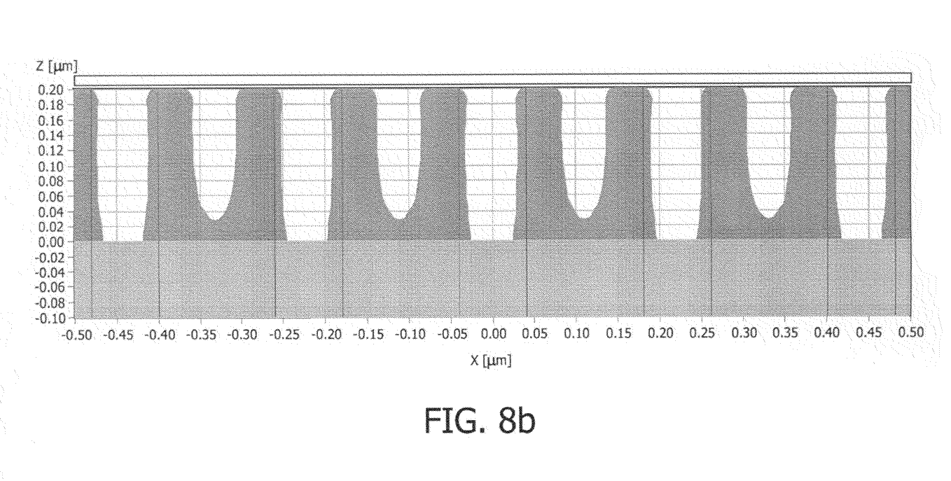

FIG. 7 is a graph illustrating the intensity distribution in the image plane after diffraction at a mask according to the first embodiment of the present invention.

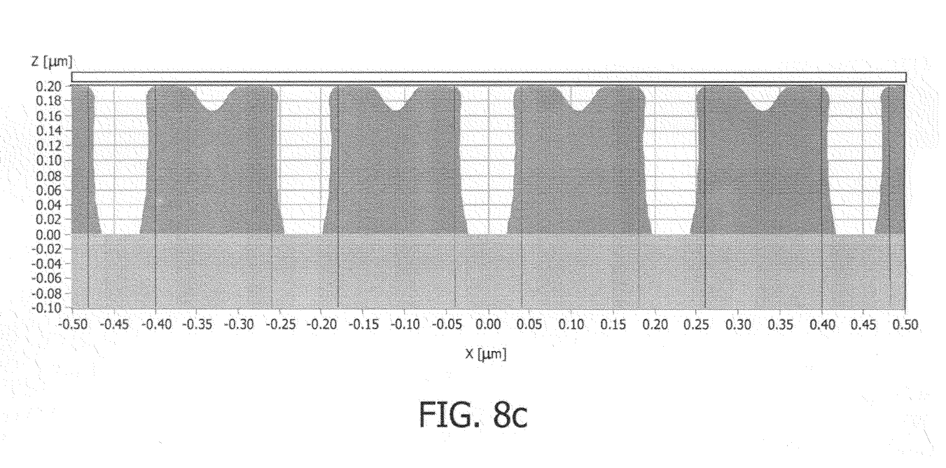

FIG. 8a to FIG. 8c illustrate simulated profiles obtained in a resist layer for differently polarized illumination beams after applying the method according to the first embodiment of the present invention.

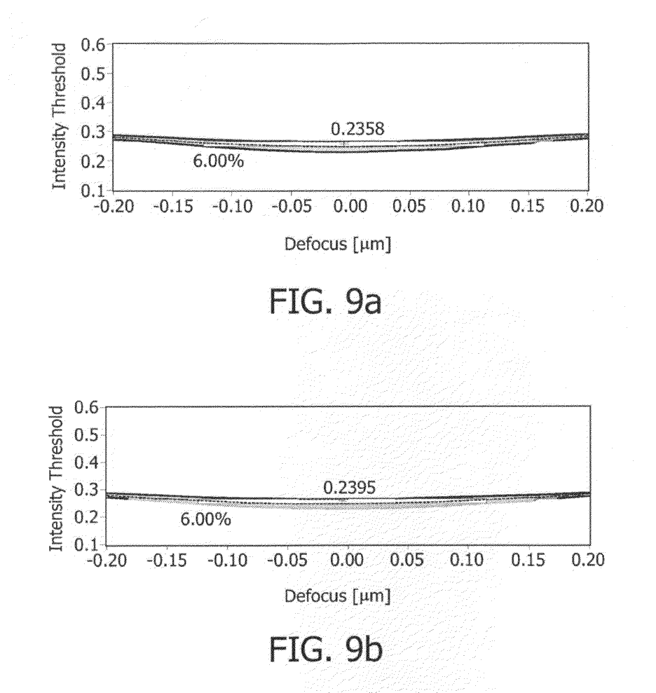

FIG. 9a and FIG. 9b illustrate the process window for illumination using a full TE polarized illumination beam respectively a 95% TE polarized illumination beam, as can be used according to the first embodiment of the present invention.

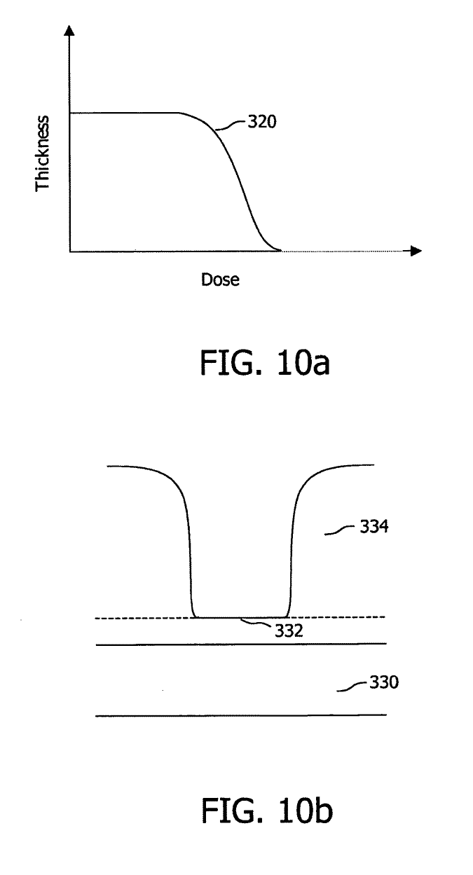

FIG. 10a and FIG. 10b describe a schematic representation of a dose-to-clear curve and the remaining resist layer after incomplete exposure as can be used in exemplary methods according to the first embodiment of the present invention.

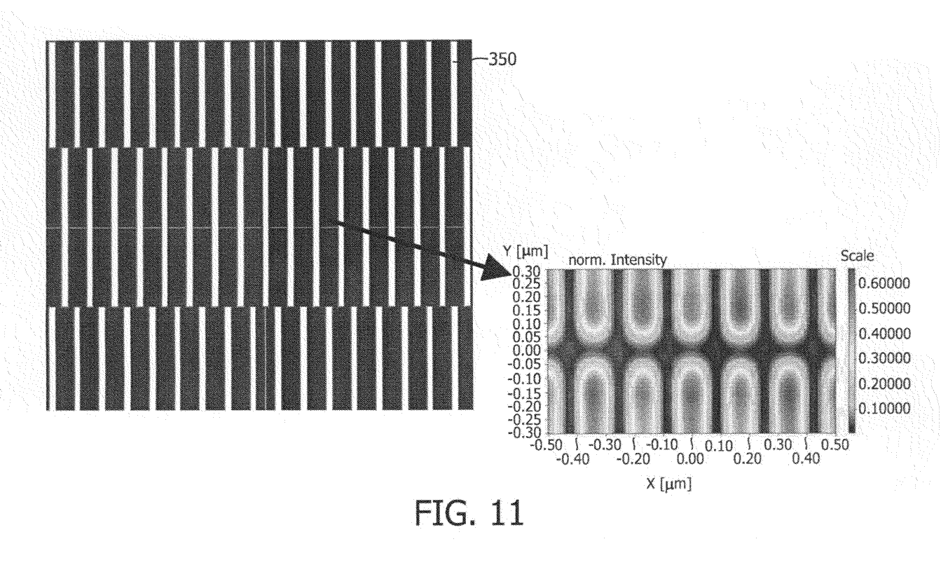

FIG. 11 illustrates a shift mask as can be used in a method according to a second embodiment of the present invention.

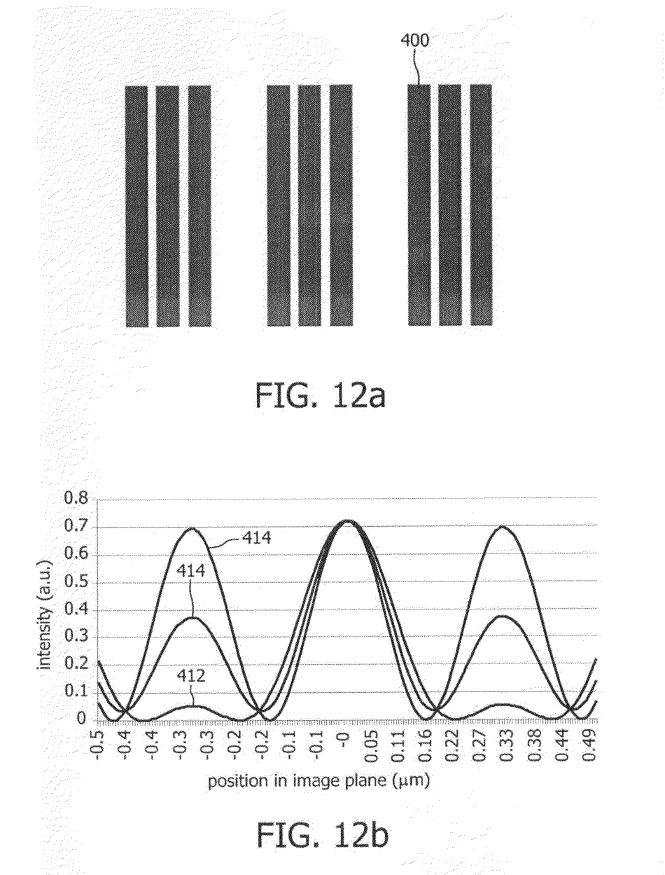

FIG. 12a illustrates a split mask as can be used in a method according to the second embodiment of the present invention.

FIG. 12b illustrates the intensity distribution of light in the image plane for differently polarized illumination beams for a split mask as shown in FIG. 11a.

FIG. 12c illustrates different types of masks that can be used in a method according to embodiments of the present invention.

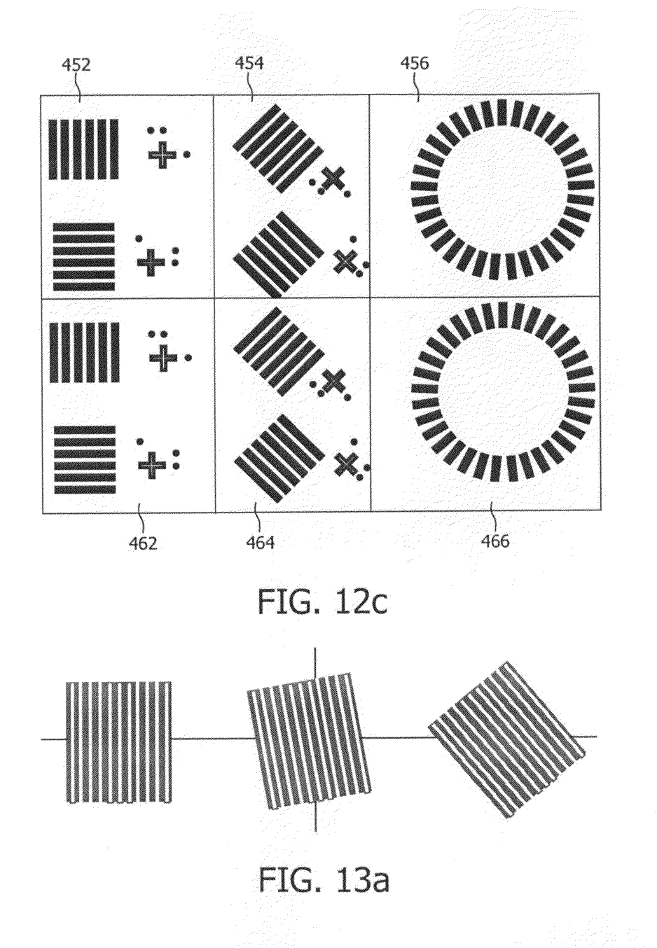

FIG. 13a and FIG. 13b show differently oriented masks and the corresponding image in the image plane as can be used according to a third embodiment of the present invention.

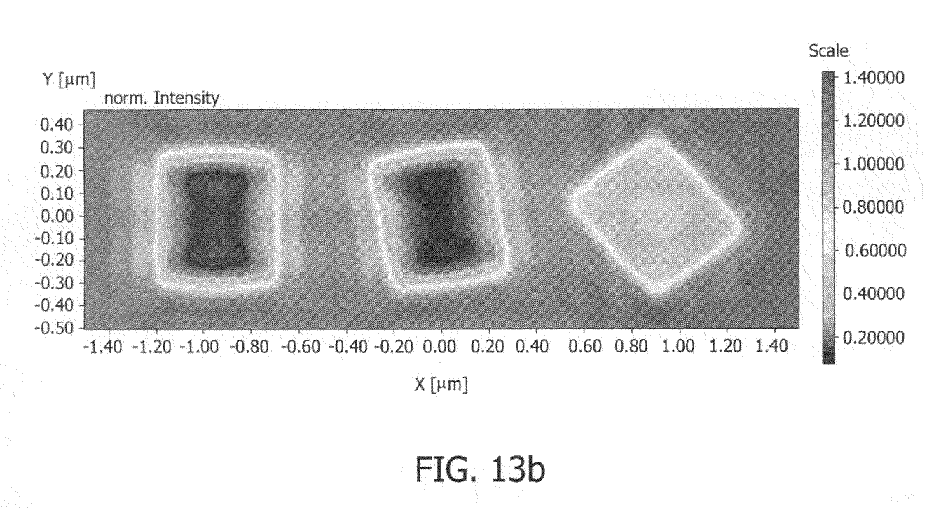

FIG. 14 illustrates a detection device having a detector incorporated in a substrate according to an embodiment of the present invention.

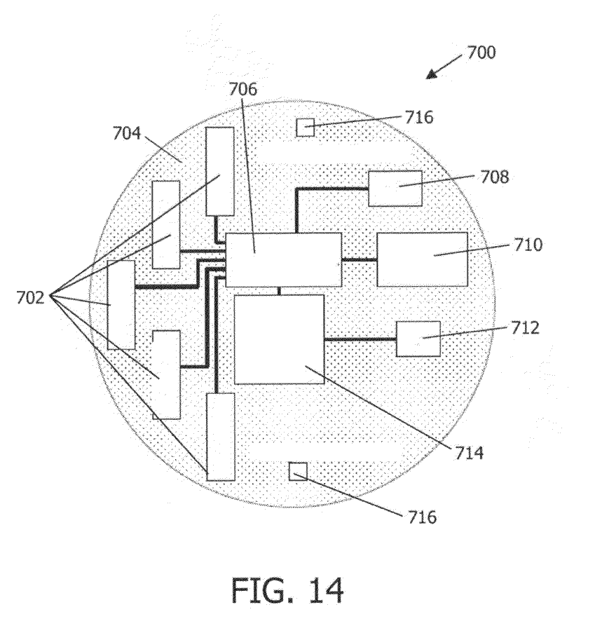

FIG. 15a and FIG. 15b show the intensity distribution beneath the standard image plane in cross-section and the intensity distribution in an out-of-focus plane for a diffraction image as can be used in a method according to a seventh embodiment of the present invention.

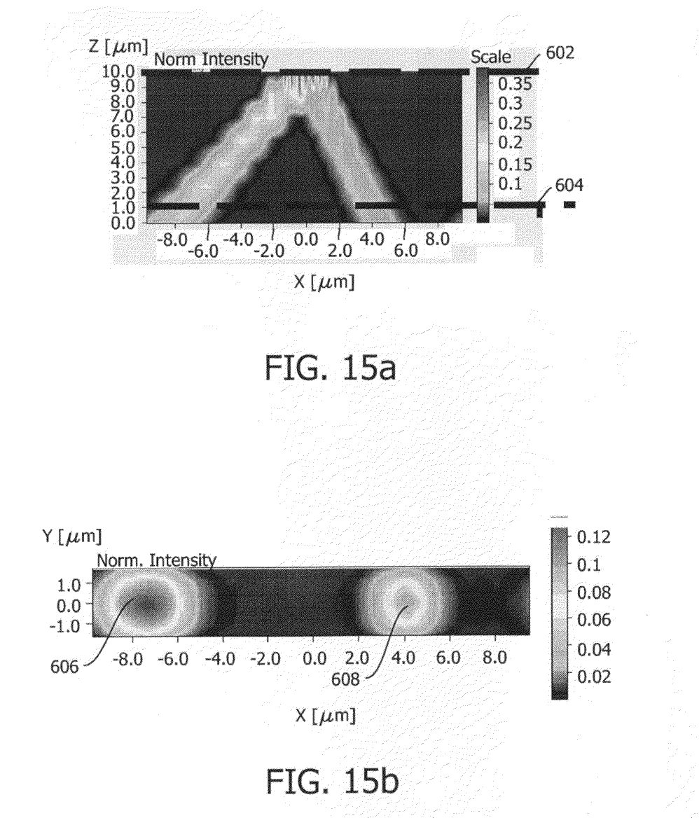

FIG. 16 shows a graph of the zero diffraction order intensity as function of the orientation of a test pattern, as can be used in a method according to a seventh embodiment of the present invention.

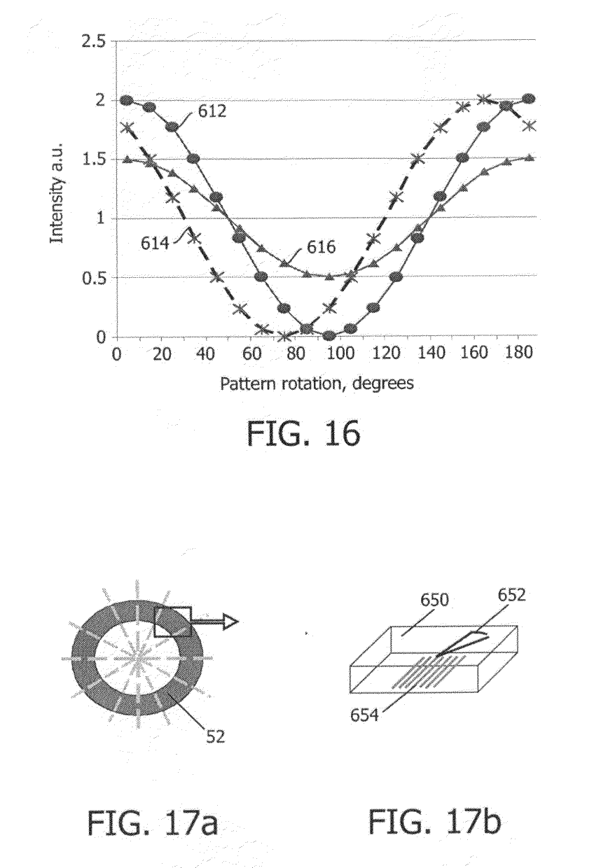

FIG. 17a, FIG. 17b, FIG. 17c, FIG. 17d show an example of an annular illumination system, a filter means for splitting the annular illumination system in monopole or dipole illumination sub-systems and a side view and top view of an optical system using such a filter means respectively for applying a method according to the seventh embodiment of the present invention to a multi-pole illumination system.

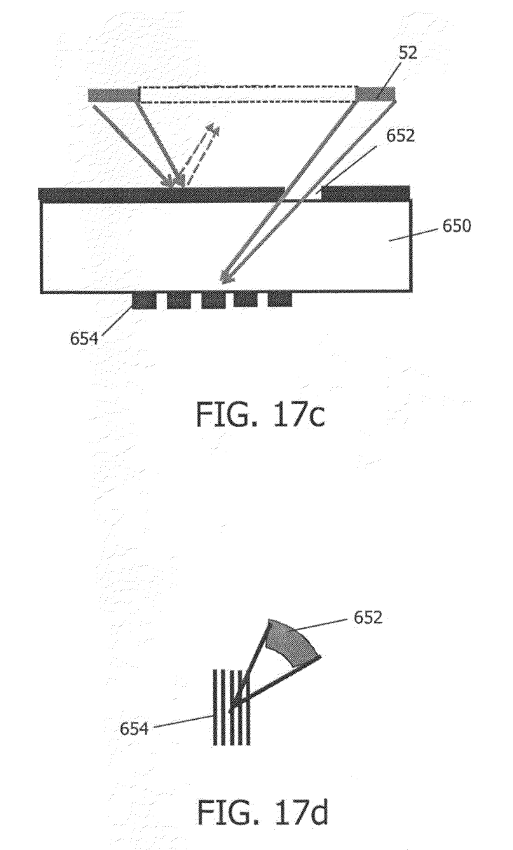

FIG. 18 illustrates typical dimensions in an optical setup using a filter means as shown in FIG. 17b.

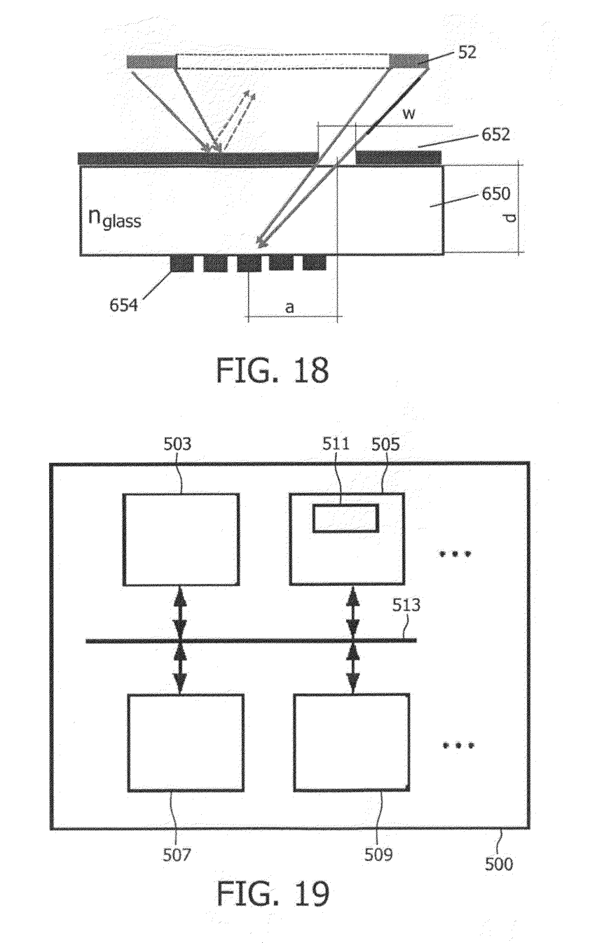

FIG. 19 indicates a computing means suitable for executing any of the methods according to the present invention or at least part of these methods, according to a further embodiment of the present invention.

In the different Figures, the same reference signs refer to the same or analogous elements.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

In the present invention, the terms “light” and/or “illumination” are used to refer to electromagnetic radiation that may be used in an optical system such as a lithographic system or a master tool. This electromagnetic radiation may comprise far infrared, infrared, near infrared radiation, visual radiation, ultraviolet radiation, i.e. both near ultraviolet radiation, deep ultraviolet radiation. The present invention can advantageously be used in optical systems using ultraviolet radiation. With ultraviolet radiation, typically electromagnetic radiation in the wavelength range between 380 nm and 7 nm is meant, whereas with deep ultraviolet radiation, typically electromagnetic radiation in the wavelength range between 250 nm and 7 nm is meant. The present invention typically may be applied for deep ultraviolet wavelengths often used in optical tools, such as e.g. 248 nm, 193 nm or 157 nm, although the invention is not limited thereto.

In a first embodiment, the present invention relates to a method for evaluating an illumination system in an optical system. The method is based on the fact that polarization effects can be introduced due to diffraction phenomena at a mask. Components of an illumination beam having a different polarization state diffract differently depending on the layout of a mask. An image obtained by illuminating a mask using an illumination beam thus may comprise sufficient information to retrieve polarization related information of the illumination beam accurately, i.e. the polarization degree of the illumination system used. In order to obtain such effects, the mask is adapted to diffract differently components of an illumination beam having a different polarization state. An optical system for which the method can be used may be a lithographic system, such as for example a stepper or scanner system, being e.g. a reflective or transmissive system, although the invention is not limited thereto. The optical system may e.g. also be a master tool. By way of example, a schematic block representation of an optical system 50, the invention not being limited thereby, is shown in FIG. 2, for which checking and/or evaluating of the polarization state of the illumination system according to embodiments of the present invention may be performed. The optical system 50 typically comprises an illumination source 51 and an illumination optics 53 comprising optical components for guiding an illumination beam (not represented in FIG. 2) emanating from the illumination system 52 towards a mask 56 on a mask holder 58. The illumination source 51 and the illumination optics 53 together form an illumination system 52. The illumination system 52 thus is the means used for illuminating the mask 56. After interacting with the mask 56, the light from the illumination beam is guided by a lens system 60 onto a substrate 64 on a substrate table 66. In the present system, immersion fluid 62 is used for obtaining a high N.A. system. The described components and other typical features that may be present in the system illustrated in FIG. 2 in general are well known by the person skilled in the art. However, a system as illustrated in FIG. 2 with the mask 56 adapted according to embodiments of the present invention is not prior art. Therefore FIG. 2 is not labeled prior art.

As mentioned above, the mask 56 provided and used in the present invention is adapted to create different diffraction effects for differently polarized components of the illumination beam. The mask 56 may be of various types, such as e.g. attenuated masks, phase shift masks, attenuated phase shift masks, alternating phase shift masks etc. The lay-out of the mask 56 can be adapted in different ways, e.g. by adapting the features, e.g. the feature size, present in the mask 56, by adapting the pitch, also referred to as pitch size, indicating the difference between two adjacent features of a mask 56, or, if possible, by adapting the degree of attenuation, by adapting the splitting present in the mask such as e.g. using a vertical or horizontal splitting, by adapting the phase shift, etc. Such adaptation may e.g. be performed by selecting a pitch size in a range having a lower limit of 0.2λ, preferably 1λ and having an upper limit of 6λ, preferably 5λ. Such adaptation may also be performed by selecting a feature size in a range having a lower limit of 0.2λ, preferably 1λ and having an upper limit of 4λ, preferably 3λ. λ thereby is the wavelength or average wavelength provided by the illumination system 52. The adaptation of the mask may also be performed by selecting a degree of attenuation between 3% and 98% or selecting the phase shift from the range 10° to 350°. A typical way of selection of a suitable layout of a mask may be, the invention not being limited thereto, by obtaining information about the numerical aperture of the system to be checked, adjusting the pitch of the layout such that the “−1” and “+1” diffraction orders, i.e. the first diffraction orders, hit the projection lens pupil, e.g. the edges of the lens pupil. Optionally, optimization of the mask layout leading to an improved performance of the method for checking the degree of polarization, may be performed by adjusting the attenuation and/or feature size, e.g. by rigorous numerical analysis of the diffraction. Optionally, phase shift and splitting also may be adjusted to further increase the accuracy of the method for checking the degree of polarization of the optical system.

The lay-out, also referred to as pattern, may be 1-dimensional, i.e. wherein the features and pitch substantially only vary in one direction or the lay-out may be 2-dimensional, whereby the features and pitch substantially vary in two different directions, possibly two orthogonal directions. For the ease of description, in the following a 1-dimensional pattern is discussed, but the invention is not limited thereto. By way of illustration, in FIG. 3, exemplary results are shown indicating differences in the ratio of TE polarized light to TM polarized light obtained after diffraction as a function of different mask layouts, in the present example being different pitch sizes. The example shows results for a 193 nm wavelength optical system. Depending on the wavelength used, typically other results may be obtained. These results are illustrated for different types of masks 56 that can be used in an optical system, such as e.g. for a silicon based binary mask indicated by curve 102 (- - -), for a chromium based binary mask indicated by curve 104 (—) for a Si₃N₄ attenuated mask with a thickness of 100 nm indicated by curve 106 (• • •) and for a Si₃N₄ attenuated phase shift mask with a thickness of 68 nm indicated by curve 108 (- • - •). The polarization changes are illustrated for initially unpolarized light. It can be seen that, e.g. in the range 600 nm to 220 nm, for decreasing pitch the alteration of the polarization is stronger. The above results are based on electromagnetic analysis of mask diffraction. In the present example, these calculations were performed using the software CYCLOP, which is described in more detail by Brok and Urbach in J. of Modern Optics 49 (2002) 1811 and in J. Opt. Soc. of America A 20 (2003) 256. The calculations were performed using a one-dimensional mask having a pattern consisting of lines and spaces. From the above it is seen that typically the smaller the pitch, the stronger the polarization alternation occurs compared to the initial polarization. Initially unpolarized incident light is thus converted into partially polarized light or in case of very small pitches into almost linearly polarized light. Preferably an attenuated phase shift mask may be used as this results in the largest diffraction efficiency disparity for the TE polarization component and the TM polarization component.

The difference in diffracted field for TE polarized light and TM polarized light is illustrated in FIG. 4a and FIG. 4b for a Si₃N₄ attenuated phase shift mask. FIG. 4a shows the diffracted field for TE polarized light, i.e. having a polarization direction parallel to the gratings' lines, whereas FIG. 4b shows the diffracted field for TE polarized light, i.e. having a polarization direction perpendicular to the grating's lines. The intensity maps shown in FIG. 4a and FIG. 4b indicate the modulus of E_{TE} respectively the modulus of E_{TM}. In both cases three different regions can be distinguished, being a quartz substrate 152, which is the mask substrate material, a Si₃N₄ pattern 154 and air 156. The disparity results in suppression of the zero diffraction order, with a suppression factor of 10 to 20 times resulting in a significant intensity difference in the resulting image. The difference in diffracted field arises from a different behavior of the TE polarization component and the TM polarization component at the grazing propagation along the boundary between the dielectric, i.e. Si₃N₄ in the present example, and air.

The different steps in a method 200 for checking and/or evaluating an illumination system 52 of an optical system 50 according to the first embodiment of the present invention are illustrated in the flow diagram of FIG. 5. In a first step 202, a mask 56 is provided in the optical system 50 comprising the illumination system 52 to be tested. As described above, according to the present invention the mask 56 is adapted for creating substantially different diffraction effects for components of an illumination beam having different polarization states. The different diffraction effects may be a different suppression of the zero diffraction orders for differently polarized light beams. Such adaptation may be performed by adapting the pitch size, the feature size, the attenuation factor, etc. of the mask 56, as described in more detail above. The latter will be used to distinguish the different components having a different polarization state and possibly to obtain information about the amount of light in the light beam having the different polarization state.

In a second step 204, an image of the mask 56, provided in the previous step, is made, using an illumination beam of the illumination system 52. The image may be obtained directly or indirectly, in any convenient way. The image may e.g. be obtained by guiding the light onto a resist layer present on a substrate 64 provided in the optical system 50 and thereafter developing the resist layer. The image thus constructed then is determined by the structure, i.e. topology, obtained after developing the resist layer. Alternatively, the image may be recorded using a detector such as a photo-detector. Such a detector may record the light intensity in the image of the mask 56. The obtained measured data 80 are also illustrated in FIG. 2 by way of example.

In a third step 206, the obtained image is evaluated and the relevant polarization related information is extracted. The polarization related information may allow to obtain the amount of light of each polarization state in the beam. The latter is representative for the polarization state of the light exiting the illumination system 52. Such evaluation may be performed using any suitable evaluation means. The evaluation means 82 are illustrated by way of example in FIG. 2. The evaluation may be performed by an operator studying and directly interpreting the obtained results, by experimentally studying the obtained results such as e.g. experimentally studying the structure obtained in a resist layer, etc. Evaluating may comprise performing an automatic evaluation based on a predefined algorithm, e.g. performed on a computing means, or based on a neural network based computer program product. The obtained result is polarization information about the illumination system 52. The polarization information may e.g. be the degree of polarization. The latter may e.g. also be obtained by comparing the experimental data with simulated or calculated results. Simulation may be based on mask optical properties provided by mask manufacturers. Other parameters such as diffraction efficiencies for different polarization settings in an illumination system may also be measured experimentally. Depending on whether the obtained image is a resist structure or an intensity profile, a resist model such as e.g. embedded models in litho-simulators or a diffused aerial image model (DAIM) may be used, which is described in more detail e.g. by C. N. Ahn, II B Kim, K II Baik, “A novel approximate model for resist processing”, Proc. SPIE 3334 (1998), p. 752. The results may be used to evaluate the quality of the illumination system 52. Such information can be used to check the initial quality of the illumination system 52, can be used to check degradation of the illumination system 52, etc. The results may also be used for estimating the capacities of a high N.A. tool and monitoring it over time. The obtained results furthermore may be used as input for high N.A. aberration measurements, where the degree of polarization is a required input parameter. In conclusion, the present method thus may be based on illuminating in an optical system 50 a mask 56 carrying a pattern such that the pattern not only behaves differently depending on the polarization degree of the illumination system 52 of the system 50, but even gives sufficiently large difference in the resulting image, e.g. an image in a resist layer or an image obtained by means of a camera, such that the polarization degree used for illumination can be retrieved from the resulting image with sufficient accuracy. The results 84 obtained from the evaluation means 82 are shown in FIG. 2 as possible input to the illumination system 52 for adjusting the system.

By way of illustration, an example is shown for a conventional type of illumination system 52, i.e. an illumination system providing normal incidence with a certain degree of spatial coherence, e.g. having a spatial coherence σ=0.2 within an angle of about 2° around normal incidence, and for a 9% attenuated phase shift mask 56 comprising 90% Si₃N₄ and 10% Si, having a refractive index of n=2.45+0.4I and a thickness of 69 nm. The feature size on mask level is 200 nm. The example shown is obtained for an optical system 50 having a magnification of ¼, i.e. the size of the pitch at wafer level typically is ¼ times the size of the pitch at mask level. The different diffraction efficiencies for the different diffraction orders as a function of the pitch size at the wafer level are shown in FIG. 6. The TE zero order diffraction is indicated by curve 302 (- • - •), the TM zero order diffraction is indicated by curve 304 (—) the TE first order diffraction is indicated by curve 306 (- - -) and the TM first order diffraction is indicated by curve 308 (• • •). It can be seen that the maximum difference value is reached at a pitch at wafer level of 150 nm, being a pitch at mask level of 600 nm. The difference between the zero order diffraction of the TE component and the TM component typically is about 40 times. It is to be noted that, depending on the type of illumination used, the first order diffraction spots may or may not contribute to the image as they may or may not hit the lens pupil of the system. In order to guarantee that the first order diffraction spots are captured in the optical system, in the present example, only systems having a N.A. larger than 1.2 can be used in case of conventional illumination.

In a second example, masks having a larger total transmission compared to the previous example are studied, allowing studying systems with a numerical aperture between 1.1 and 1.2. The thickness of the material together with the refractive index must give rise to a phase shift of π and the transmission of the layer should be about 20%. The latter is, in the present example, obtained by setting the phase shift to π, and first obtaining information about the numerical aperture of the optical system to be controlled, then finding a pitch such that the first diffraction orders hit the projection lens pupil, e.g. the edges of the projection lens pupil, and then adjusting the attenuation and feature size through rigorous numerical analysis of the obtained diffraction. The splitting, i.e. horizontal or vertical, can optionally be further adjusted in order to try to further increase the accuracy of the obtained results.

Some examples of masks that can be used are a 20% attenuated phase shift mask having a pattern with refractive index n=2.45+0.3i, made of Si₃N₄ and 69 nm thick, a 20% attenuated phase shift mask having a pattern with refractive index n=2.5+0.3i, made of 92% Si₃N₄ and 8% Ag and 66 nm thick. The feature size in these masks is selected to be 60 to 90 nm and the pitch at wafer level is 170 nm to 240 nm. If e.g. a 80 nm feature size is selected and a 220 nm pitch size at wafer level, the zeroth order TE efficiency is suppressed with a factor 20 compared to the TM zeroth order efficiency, while the TM zeroth order efficiency is about 7 times smaller than the first diffraction orders of TE and TM polarized light. The resulting aerial image for a TE polarized beam indicated by curve 312, a TM polarized beam indicated by curve 314 and an unpolarized illumination beam indicated by curve 316, influenced by their different zero order efficiencies, are shown in FIG. 7. A difference in intensity ratio between the different diffraction orders can be seen, mainly determined by the difference in suppression of the zero diffraction orders. The main peak, visible at the left and right hand side of the graph, and the side lobe, visible in the center of the graph, can be seen for different types of polarization of the illumination beam.

Different feature sizes and corresponding pitches may be chosen for the mask 56, depending on which range of lens pupil filling factors are available in the optical system 50 and depending on the degree of accuracy by which the degree of polarization is to be obtained. A smaller feature size and pitch size will increase the diffraction angle for the first order radiation peaks, possibly resulting in non-capturing of part of their energy by the projection lens.

In a third example, a method for checking and/or evaluating an optical system having a numerical aperture (NA) between 0.85 and 0.93 is illustrated. The total transmission of the mask 56 should be increased comparing to the previous examples. The thickness of the material together with the refractive index must give rise to a phase shift π and the transmittance of the layer should be about 30%, i.e. a mask should be used being a 30% attenuated phase shift mask with a refractive index of n=2.45+0.25i, a feature size between 90 nm and 120 nm and a pitch size at wafer level between 240 nm and 320 nm. Besides a Si₃N₄ based attenuated phase shift mask, other materials such as MoO₃—SiO₂, SiO₂—Ta₂O₅, TaN—Si₃N₄ can be used in the mask production. Typically such materials are to be selected such that their thickness and refractive index give rise to the phase shift π, while the absorbing part is adjusted according to the pattern dimensions used in the method.

Preferably, both zero and first order diffraction beams are within the lens pupil as it results in image formation which allows evaluation of both the polarization effects induced by the lens and the polarization effects obtained at the mask level, i.e. polarization effects occurring in the illumination system.

Thus, the intensities of the intensity peaks in the image plane, i.e. main peaks and side lobes, are almost equal for the TE mode, whereas this is not the case for unpolarized light or for light being TM polarized. Depending on the type of polarization, the critical dimension of the lines of the pattern in the image will, after diffraction, either be influenced or will not be influenced. Measuring the critical dimension of the printed lines thus allows retrieving the degree of polarization that has been used for mask illumination. If the intensity of the side lobe is half of the intensity of the main peak for unpolarized light, the change of the ratio of the intensity of the sidelobe to the intensity of the main peak, i.e. I_{sidelobe}/I_{main peak}, with the change of the polarization change will be largest, or in other words, the variation of this ratio with the change in polarization change will be largest. The latter results in a high sensitivity for detecting such a change in polarization state.

In order to further illustrate the method according to the present invention, an example of a print obtained in the resist layer is provided, after illumination through a mask adapted for diffracting in a substantially different way radiation components having a substantially different polarization state. The results are shown for a complete TE polarized light beam, as shown in FIG. 8a, for a partially TE polarized light beam having a degree of polarization of 0.95, as shown in FIG. 8b and for an unpolarized light beam. The simulated results are shown for an optical system having a numerical aperture 1.2 and a lens filling factor σ of 0.25, and a mask having feature size 80 nm and pitch size 220 nm. The printed lines and the side lobes can be seen. The simulations are based on a standard resist model, such as e.g. Solid-C (www.Sigma-c.com) or ADDIT which is described in more detail e.g. by David Van Steenwinckel, Jeroen Lammers Proc. SPIE Vol. 5039, p. 225-239, 2003. From these simulations, assuming that with a scanning electron microscope (SEM) the critical dimensions can be measured with an accuracy of about 1.5 nm to 2 nm, it can be derived that the obtained accuracy for the obtained degree of polarization is better than 10%, preferably better than 7%, more preferably better than 5%, even more preferably better than 3%. The highest accuracy can be obtained using e.g. a split pattern, as will be described further.

A good theoretical accuracy can be obtained for optical systems having a numerical aperture of 1.3 or smaller. This can be seen as follows. FIG. 9a and FIG. 9b indicate the process windows for dense lines and spaces having a feature size of 50 nm and a distance between the features of 50 nm for both a TE polarized light beam and a partially TE polarized light beam having a polarization degree of 0.95. It can be seen that, for given exposure conditions, a difference of 5% in the polarization degree results only in a 5 nm difference in depth of focus (DOF). It is to be noted that although there are patterns and illumination settings that affect the polarization quality more than described above, the accuracy is not drastically changed. 10% accuracy therefore is a reasonable value for polarization quality control. It also is to be noted that the estimated theoretical error may be influenced by experimental process variations and random errors.

In order to further illustrate the method according to the present invention, further exemplary methods are illustrated in the following examples, whereby obtaining images and evaluation of the obtained images is performed taking into account the amount of resist removed during a develop step based on the illumination it has received. The latter may be referred to as dose-to-clear parameters. Typically in the present examples, the image of the mask obtained may be an image obtained in a resist layer or a simulation thereof. Small changes in the light intensity typically may have a large impact on the amount of resist that is removed during a develop step in the lithographic process of a device. A typical resist may exhibit for example, the invention not limited thereto, a dose-to-clear curve that shows complete loss of 200 nm resist during a dose change of about 1 mJ/cm² at intensities of 5 to 10 mJ/cm². Typical curves that relate resist thickness and light dose are called dose-to-clear plots and an example thereof is shown in FIG. 10a. Such a curve 320 also may be referred to as a contrast curve. FIG. 10b illustrates an incomplete exposed resist 334 on a substrate 330 with the remaining resist 332 remaining due to such incomplete exposure. The latter may be used for measuring a dose-to-clear plot by measuring the thickness of the remaining resist 332 for different exposure doses.

In a first exemplary method information about the dose-to-clear parameter DO of the resist is determined by exposing a substrate with resist layer with an energy meander through a mask blank, i.e. a region of the mask which does not comprises patterns. Furthermore, a substrate with resist layer is exposed with an energy meander through the test pattern used for quantifying the polarization, and described in more detail above. Evaluation of the obtained images of the test pattern then is performed by determining the dose to clear parameters for both exposures, resulting in a dose to clear parameter for the mask blank DO_{mask blank} and a dose to clear parameter for the test pattern DO_{test pattern}. By correcting the dose-to-clear parameter with the transmission factor [0<t<1] of the test patterns, a theoretical dose-to-clear curve for an assumed polarization state can be calculated. The difference between the two curves is equal to the energy in the polarization state filtered out by the test pattern. Labeling the transmitted polarization state TE and the filtered out state TM, the following equations yield the Degree of Polarization (DOP)

$${DO}_{TP} = {DO}_{TE}$$

$$t * \frac{1}{{DO}_{MB}} = \frac{1}{{DO}_{TP}} + \frac{1}{{DO}_{TM}} . \\ DOP = \frac{( {DO}_{TE} - {DO}_{TM} )}{( {DO}_{TE} + {DO}_{TM} )}$$

In a further exemplary method, exposures of vertical and horizontal test patterns using an energy meander are performed and the dose to clear parameters for both gratings, then referred to as DO_{TE} and DO_{TM}, which can be determined from the exposures, allow to determine the degree of polarization (DOP) immediately using

$$DOP = \frac{( {DO}_{TE} - {DO}_{TM} )}{( {DO}_{TE} + {DO}_{TM} )}$$

The above methods describe exemplary methods for illumination and evaluation of images of the mask pattern, leading to evaluation of the polarization state of the illumination system used.

In a second embodiment, the invention relates to a method as described in the first embodiment, having the same steps, features and advantages as the method of the previous embodiment, but wherein the mask is provided with additional features to improve the obtained experimental results. The mask 350 may for example comprise a large amount of features, e.g. lines and spaces, such as e.g. at least 25 features, more preferably at least 50 features. The latter leads to a more confined diffracted field and allows for statistical analysis of the critical dimensions of the printed structure. Alternatively, or in addition thereto, the mask 350 may comprise a shifted grating, as e.g. shown in FIG. 11, which leads to an improved robustness to process related defects, i.e. for example post exposure defects such as line collapsing or distortion at the line ends. With a shifted grating pattern is meant that at least a portion of the pattern is shifted with respect to a remaining portion of the pattern.

Another additional or alternative feature is defined by a pattern 400 resulting in a large difference between the TE polarized light and other polarized or unpolarized light, allowing to thus improve the accuracy of the method for determining the polarization state of the illumination system. Such a pattern 400 may be e.g. a split pattern, whereby the transmission of the zero order of the TM polarized component is increased compared to a mask 350 having a large number of features, but whereby still a high number of features are present. The latter thus combines high transmission with a substantially confined diffraction. An exemplary pattern 400 is shown in FIG. 12a illustrating a split pattern. FIG. 12b illustrates the corresponding light intensity in the image plane when using the pattern 400. The result for a TE polarized light beam, indicated by curve 412, a TM light beam indicated by curve 414 and an unpolarized light beam, indicated by curve 416, are illustrated. It can be seen that the contrast difference and consequently the difference in critical dimensions is large. The latter results in a higher accuracy for determination of the polarization state. A further advantage of a split pattern is that it is more robust to differences in angle of incidence. Therefore, it can also be used in methods and systems for checking the polarization state of so-called off-axis type illumination systems, such as dipole light systems, quadrupole light systems, etc.

By way of illustration, other examples of masks that can be used are indicated in FIG. 12c. Three different mask lay-outs 452, 454, 456 allowing to generate a zero and first order diffraction beam within the projection lens pupil are indicated at the top of FIG. 12c, whereby the lay-outs 452, 454 require a reference feature to indicate the orientation of the mask in the image afterwards, while 456 is point-symmetrical and does not require a reference feature to indicate the orientation. Three different mask lay-outs 462, 464, 466 have an adapted pitch size such that the generated first order diffraction beams are positioned outside the lens pupil, leading to formation of only an intensity image, as will be discussed in more detail in the third embodiment. Whereas lay-out 462 and 464 comprise reference features to indicate the orientation of the mask in the image afterwards, 466 does not require such a reference feature as it is point-symmetrical.

Another advantageous feature occurs when experimental data contain an energy meander at the best focus position. In other words, the experimental data may contain, for a best focus position, a number of measurements obtained for different illumination intensities. The latter may allow to obtain more accurate results. Similarly, the obtained experimental data may contain measurements for a complete Focus-Exposure Matrix, whereby both intensity and focus are varied allowing to obtain accurate information about the illumination system polarization and even information about the projection lens polarization effects.

In a third embodiment, the present invention relates to a method for checking and/or evaluating a polarization state of an illumination system in an optical system as described in any of the previous embodiments, but wherein the image obtained specifically is a complete 2D image. Providing a mask resulting in a specific 2D image may e.g. be based on the principle of splitting the physical functionality of the pattern in two parts, i.e. a first part acting as a wire grid polarizer and a second part acting by introducing a difference in zero order suppression. In the case of a part introducing a difference in zero order suppression, an attenuated phase shift mask can be used. As a combination of a line width and a pitch can be found that results in a maximum difference in zero order transmission and whereby only the zero diffraction orders are located in the lens pupil, no image of lines will be formed by a line pattern, but a complete area will be imaged. The image of the complete area is then formed according to the transmittance of the zero order transmission, which depends on the orientation of the lines in the mask and the orientation of the polarization vector. The latter is illustrated in FIG. 13a and FIG. 13b. It is to be noted that for masks based on differences in zero order transmission, the transmission typically will be small, e.g. about 1%. The latter can be increased by using a splitted mask type as described in the second embodiment. A transmission of up to 10% may then be obtained. It furthermore is to be noted that, as no image is formed and only the passed intensity of the light is registered, only evaluation of the degree of polarization in the illumination system can be obtained, but no changes in polarization due to the projection lens can be evaluated. In a preferred embodiment, providing both features in a mask resulting in a part of the image being a 2D image and features in a mask resulting in a part of the image being a 1D image is advantageous, as it provides data that allows substantially increasing the accuracy of the measurements. In such an embodiment the method and corresponding mask combines the features of embodiments 1 and/or 2 with the features of embodiment 3.

For wire grid polarizers a similar behavior is obtained. It is nevertheless to be noted that wire grid polarizers have a strong technical drawback as they require e-beam manufacturing due to the small dimensions required for efficient deep UV workability, i.e. that they require sub-nanometer features and pitch size. Furthermore, wire grid polarizers do not allow to obtain first order diffraction beams at the projection lens pupil, thus not allowing performing the efficient method as described in the present invention.

In a fourth embodiment, the present invention relates to a means for evaluating and/or a test kit for evaluating the polarization state of an illumination system in an optical system. The means for evaluating and/or test kit for evaluating the polarization state of an illumination system comprises a mask adapted for substantially differently diffracting incident components of a light beam having a different polarization state. The mask may be of various types, such as e.g. binary masks, attenuated masks, phase shift masks, attenuated phase shift masks, alternating phase shift masks etc. The lay-out of the mask may be adapted in different ways, e.g. by the features present in the mask, i.e. for example by their feature size, by the pitch, also referred to as pitch size, indicating the difference between two adjacent features of a mask, if present, by the degree of attenuation, by the phase shift, by the splitting, e.g. horizontal or vertical splitting, etc. Such adaptation may e.g. be performed by selecting a pitch size in a range having a lower limit of 0.2λ, preferably 1λ and having an upper limit of 6λ, preferably 5λ. Such adaptation also may be performed by selecting a feature size in a range having a lower limit of 0.2λ, preferably 1λ and having an upper limit of 4λ, preferably 3λ. λ thereby is the wavelength or average wavelength provided by the illumination system 52. Adjustment of the degree of attenuation may be performed in a range between 3% and 98% and a phase shift may be selected from the range 10° to 350°. Typically, the invention not being limited thereto, selection of a suitable layout of a mask may be performed by obtaining information about the numerical aperture of the optical system, adjusting the pitch such that the first diffraction orders hit the lens pupil, optionally optimizing by adjusting the attenuation and/or feature size, e.g. by numerical analysis of the diffraction and further optionally adjusting the phase shift and the splitting of the mask. The lay-out, also referred to as pattern, may be 1-dimensional, i.e. wherein the features and pitch substantially only vary in one direction, or the lay-out may be 2-dimensional, whereby the features and pitch substantially vary in two different directions. The number of features may be large, e.g. at least 25 features, more preferably at least 50 features. The latter leads to a more confined diffracted field and allows for statistical analysis of the critical dimensions of the printed structure. Alternatively, or in addition thereto, a shifted pattern may be provided, leading to an improved robustness to process related defects. The pattern of the mask may be a split pattern, i.e. comprising areas with a high feature density and areas without features resulting in a higher transmission while still providing a substantially confined diffraction. Another advantageous feature occurs when the experimental data contain an energy meander at the best focus position, i.e. data for different illumination intensities, or even data for a complete Focus—Exposure matrix, i.e. data for different illumination intensities and different focusing settings. The mask in the means for evaluating and/or the test kit for evaluating the polarization state of an illumination system may furthermore be provided with a filter for splitting a multi-pole illumination system into a plurality of monopole or dipole illumination systems, e.g. in a plurality of monopole illumination systems. The latter may be advantageously used in a method for evaluating the polarization state of an illumination system as described in the seventh and eighth embodiment. Furthermore, the mask may also be provided with a quarter wavelength plate in order to determine circular polarization states. The means for evaluating and/or the test kit for evaluating also may comprise at least one substrate carrying a resist layer. The resist layer may be made of a standard resist. It may be positive or negative resist and the mask may, but does not need to, be adapted to the type of resist. The means for evaluating and/or test kit for evaluating may also comprise a detector for registering the light intensity. The detector may be a photo-detector means, such as e.g. a camera. In a specific embodiment, the present invention also relates to a detector adapted for being positioned at an image plane of an optical system and furthermore adapted for recording an image of a mask diffracting incident components of a light beam having a different polarization state substantially differently. The detector thus is adapted for recording an image as performed in any of the methods described in embodiments 1 to 3. The detector or detecting means may be incorporated or positioned on a substrate, such as e.g. a wafer such that it can easily be positioned on a substrate stage, e.g. a wafer stage. The latter has the advantage that positioning of the detector in the optical system is easy. In other words, in a specific embodiment the present invention also relates to a device 700 which comprises at least one detector 702 incorporated in a substrate 704, as shown in FIG. 14. The substrate 704 typically may have the shape and dimensions of a production wafer for use in the apparatus of which projection system the aberrations have to be measured. It provides the advantage that it can be easily loaded in and unloaded from the apparatus, like a production wafer. Typically the substrate 704 may comprise a number of detectors 702 providing the sensor signal to a microprocessor 706. The device 700 furthermore may comprise a synchronization means 708, a power supply 710, input and output devices 712, a memory 714 and alignment features 716 for appropriately aligning the device 700.

In a fifth embodiment the present invention also relates to an optical system having an illumination system optimized and/or evaluated and/or maintained using any of the methods as described in the first, second and third embodiment and as will be described in the seventh and eighth embodiment of the present invention and/or comprising an evaluating means as described in the fourth embodiment. The optical system may e.g. be a lithographic system or a master tool. The optical system may be a stepper or scanner system. The optical system may be any of a reflective or transmissive system. The optical system may be adapted for receiving a detector as described in the previous embodiment. Alternatively, or in combination therewith, the optical system also may comprise a detector integrated at a substrate stage such that it can be positioned at an image plane of the optical system. The detector typically is adapted for recording an image of a mask diffracting incident components of a light beam having a different polarization state substantially differently. It may be incorporated in a substrate as described in the fourth embodiment. The detector therefore is especially suitable for recording an image in a method for evaluating the polarization state of an illumination system in an optical system according to any of embodiments 1 to 3. The optical system furthermore typically comprises an illumination system for illuminating a pattern and optics for guiding light influenced by the pattern to an image plane. Other components that typically may be present in the optical systems are well known by the person skilled in the art, some of them being illustrated in FIG. 2. Optical systems with an integrated detector have the advantage that they allow quick and frequent testing of the polarization state of the illumination system.

In a sixth embodiment, the present invention also relates to a method for deriving a degree of polarization of an illumination system in an optical system from a recorded image or pattern in a resist layer. Such a recorded image or pattern typically is obtained by performing the mask providing step and illumination step of any of the methods for evaluating the polarization state of an illumination system according to embodiments 1 to 3. The method for deriving a degree of polarization of an illumination system according to the present embodiment comprises obtaining related information about the recorded image or pattern in the resist layer. This related information may be the image itself, e.g. in case of a recorded image, or may be an image of the pattern obtained in the resist layer, like e.g. one or more scanning electron microscope images of the pattern obtained in the resist layer. This related information typically may be inputted in a computing means, where the related information is processed to obtain data related to the polarization state of the illumination beam used for generating the recorded image or pattern in the resist layer. Such processing may be done by an operator or may be done automated, based on a predefined algorithm or based on a neural network. Comparison with a database of previously obtained results or reference results also may be performed. In order to perform automated processing, details about the mask used for obtaining the recorded image or pattern in the resist layer may be provided. Furthermore the processing step may comprise similar features as described in step 206 of the method shown in FIG. 5. The method for deriving a degree of polarization of an illumination system in an optical system from a recorded image or pattern in a resist layer also may be based on dose-to-clear measurements, as indicated and further described in particular examples of the first embodiment, the method comprising the same features and advantages as indicates in these examples. The method for deriving a degree of polarization of an illumination system in an optical system from a recorded image or pattern in a resist layer also may be based on evaluation of a diffraction image, as indicated and further described in the seventh and eighth embodiment according to the present invention, the method comprising the same features and advantages as described in these embodiments. The processing allows to obtain data related to the incident components of an illumination beam having a different polarization state and this data allows to derive polarization related information about the illumination system, such as e.g. the degree of polarization of the illumination system.

In a seventh embodiment, the invention relates to a method for evaluating an illumination system in an optical system as described in the first, second and third embodiment according to the present invention, wherein the obtained image is a diffraction image. In other words, the seventh embodiment relates to a method for evaluating an illumination system in an optical system wherein, in a first step a mask is provided in the optical system. The mask thereby is adapted so as to diffract in a substantially different way incident components of an illumination beam having a different polarization state. The mask and the providing thereof is described in more detail in the above described embodiments. In the present embodiment, the same features and advantages occur as described for the corresponding step in the previous embodiments. The method for evaluating furthermore comprises obtaining an image of the mask using an illumination beam of the illumination system that is incident on the mask. In the present embodiment the obtained image is a diffraction image of the mask. The diffraction image typically indicates at least the zero order diffraction, e.g. a number of different diffraction orders diffracted by the mask. The image thereby typically may be taken substantially out of focus, such that a diffraction image is obtained allowing to distinguish the at least the zero-order diffraction. Obtaining a diffraction image of the mask may be performed in any suitable way, e.g. using a direct as well as an indirect method. It may e.g. be obtained by guiding the light onto a resist layer present on a substrate and thereafter developing the resist layer, the resist being irradiated in an out of focus plane. Another example for obtaining a diffraction image of the mask is based on recording an image using a detector, such as e.g. a photo-detector. Such a detector may record the light intensity in the diffraction image of the mask. The image typically may be taken substantially out of focus in order to obtain a diffraction image of the mask. By way of example, the invention not being limited thereto, a cross-sectional intensity distribution beneath the standard image plane 602 and a top view of a diffraction image in an out-of-focus plane 604 is shown in FIG. 15a and FIG. 15b respectively. The intensity distribution is shown for a single pole (monopole) off axis illuminator. From FIG. 15a and FIG. 15b it can be seen that by recording the irradiation in an out-of-focus plane 604, information about the zero diffraction order 606 can be clearly separated from other diffraction orders 608. Furthermore, it is clear from FIG. 15a and FIG. 15b that by placing the detector out of focus, in the present example about 10 μm below the image plane 602, measurement of the zero diffraction order 606 intensity can be performed. In a preferred embodiment, in order to evaluate the image to extract polarization related information about the illumination system, images are obtained for several pattern orientations as discussed in more detail in the previous embodiments. In a third step, evaluating the image to extract polarization related information about the illumination system is performed. Information about the diffraction image may be used for extracting polarization related information. Such an evaluation typically may comprise determining a parameter of a predetermined diffraction order, e.g. the zero diffraction order, although the invention is not limited thereto and higher diffraction orders, if they exist may be used as well. A parameter of a predetermined diffraction order may be any suitable parameter such as an intensity, e.g. an integrated total intensity in a beam corresponding to the predetermined diffraction order, or a polarization of the beam. Using the polarization may result in information about the polarization of the projection lens as polarization of the beam typically is changed during propagation through a projection lens. Such an evaluation for example typically may comprise determining the intensity of the zero diffraction order for the obtained image(s). From the intensity of the predetermined diffraction order, e.g. the zero diffraction order, information related to the polarization state may be obtained. In a preferred embodiment, evaluating may comprise determining the intensity of the predetermined diffraction order, e.g. zero diffraction order, for different pattern orientations. The latter may result in information expressing a parameter of the predetermined diffraction order, e.g. the zero diffraction order intensity, as function of the orientation of the pattern imaged. In FIG. 16, an example zero diffraction order as function of the orientation of the pattern imaged is shown by way of example for a linear polarized illumination system 612, indicated by discs, for a rotated linear polarized illumination system 614, indicated by crosses, and for a depolarized illumination system 616, indicated by triangles. It can be seen that the maximum and minimum intensity of the zero diffraction order depends on the degree of polarization (DOP) and that rotation of a linearly polarized illumination system results in a shift of the pattern, not in a change of the minimum and maximum intensity of the zero diffraction order as function of the pattern orientation. It has been found that left or right shift of the curve indicates that the linearly polarized light is rotated, while reduction of the amplitude of the curve indicates partial depolarization. It also has been found that fully unpolarized light does not result in modulation of the zero order diffraction intensity versus the pattern orientation at all. Extracting polarization related information about the illumination system therefore may comprise evaluating the shape of the curve representing a parameter value of the predetermined diffraction order, e.g. the intensity of the zero diffraction order, as function of the orientation of the pattern used for imaging. In a further preferred embodiment, the degree of polarization can be determined by determining the maximum and minimum value of a parameter of the predetermined diffraction order, e.g. the maximum and minimum intensity of the zero diffraction order versus pattern orientation information and using the obtained intensity and angle information for determining the degree of polarization. The degree of polarization is defined by following equations, i.e.

$$( \begin{matrix}{S}_{0} \\ {S}_{1} \\ {S}_{2} \\ {S}_{3}\end{matrix} ) = ( \begin{matrix}{I}_{0}^{2} + {I}_{90}^{2} \\ {I}_{0}^{2} - {I}_{90}^{2} \\ 2 {I}_{0} \cdot {I}_{90} \cdot cos δ \\ 2 {I}_{0} \cdot {I}_{90} \cdot sin δ\end{matrix} )$$

whereby S₀, S₁, S₂ and S₃ represent the Stokes components that describe the polarization state of the light, I₀ represents the intensity at a non-rotated pattern orientation and I₉₀ represents the intensity at a 90° rotated pattern orientation. The angle δ expresses that linearly polarized light is rotated from its “0” or “90°” orientation. The degree of polarization (DOP) then may be expressed as

$$DOP = \frac{{S}_{0}}{{S}_{1}}$$

S₀ represents the total intensity of the light, S₁ is an indication of the amount of linear horizontal polarization (LHP) or the amount of linear vertical polarization (LVP) of the light, S₂ is an indication of the amount of light being linear polarized and making an angle of 45° or an angle of −45° and S₃ is an indication of the amount of right circular polarized or left circular polarized light. In order to determine S₃, which is not needed to determine the degree of polarization but provides additional information about the polarization, typically a quarter wave plate is applied on top of the reticle used, to be able to measure circular polarized light. For the results shown in FIG. 16, corresponding with horizontally polarized light, I₀ represents the maximum intensity corresponding with the “0” degree pattern rotation and I₉₀ corresponds to the minimum intensity corresponding with the “90” degree pattern rotation. It is to be noticed that in systems according to the present embodiment, no stringent requirements are imposed on the detector for detecting the diffraction image. The detector may e.g. be a low resolution detector, e.g. having a detector with small numerical aperture e.g. N.A. not larger than 0.5. It is an advantage of particular embodiments of the present invention that detection of the diffraction image may be performed at different positions on the light path.

In an eighth embodiment, a method for evaluating an illumination system in an optical system as described in the seventh embodiment is envisaged, wherein the system is adapted for more easily qualifying and/or quantifying multi-pole illuminators, such as e.g. quadrupole illuminators or annular illuminators, e.g. all illuminators except monopole illuminators or all illuminators except monopole and dipole illuminators, the invention not being limited thereto. The method comprises the same steps and the same embodiments as described for the method of the seventh embodiment, but for obtaining an image, additional filtering is performed in the illumination. Typically for qualifying and/or quantifying multi-pole illuminators, the illumination is split up in monopole or dipole illumination, e.g. in monopole illumination, by filtering the total illumination pattern. The latter may e.g. be performed by placing a filter with appropriate transmission between the reticle and the illumination system. Such a filter may e.g. be an opaque layer with appropriate openings allowing monopole illumination or dipole illumination, e.g. monopole illumination, or equivalents thereto to illuminate the reticle. Not applying such a filter typically would result in a high number of diffraction orders that are very difficult to discriminate, leading to a complicated analysis. By applying the filter as described a multi-pole illumination system can be split up in a number of illumination systems that can be separately be evaluated using the method as described in the seventh embodiment. Typically the filter may be placed on top of a mask blank whereas the pattern to be imaged is located at the bottom of a mask blank. Alternatively, the filter also may be introduced at another position between the illumination system and the reticle. Thus, measuring the polarization state for every pole, the polarization map of the total illuminator is reconstructed from several monopoles. Using the monopoles allows easier separation of diffraction orders at the out-of-focus zero order measurements. In a particular example according to the present embodiment, splitting of an annular illumination system is described. In FIG. 17a an annular illumination system 52 is schematically represented. In FIG. 17b, a mask blank 650 with an applied filter 652 at the top side and an applied pattern 654 at the bottom side is indicated. FIG. 17c and FIG. 17d provide respectively a side view and a top view of an optical system. Typical dimensions for an exemplary arrangement are shown in FIG. 18, the invention not being limited thereto. The radial position a of the opening in the opaque layer from the center of a pattern can be defined by

$$a = \frac{d \cdot tan ( σ )}{{n}_{blank}} ; where σ = NA / 4$$

in which d is the thickness of the mask blank, n is the refractive index of the mask blank, sigma is the illumination setting which depends on the NA (numerical aperture) of a lithographic tool. For a system having a numerical aperture of 1.2, a blank mask thickness of 5 mm, a sigma of 0.75, the position of the opening in the filter may e.g. be 0.73 mm. The width of the opening typically may be of the order of 0.29 mm.

The manufacturing of the filter 652 may be performed in many different ways. The filter 652, e.g. opaque layer, may e.g. be deposited on top of the mask blank 650 and may be patterned before the processing of the other side, whereon the pattern 654 is to be provided. Due to relatively large dimensions of the features in the filter 652, e.g. opaque layer, the process is rather easy. Another exemplary option to make a filter 652, e.g. opaque layer, on top of the mask blank 650 could be the manufacturing of a thin absorbing plate (<1 mm), e.g. a metal plate, with appropriate holes in it and positioning the thin absorbing plate with respect to the pattern 654 on the bottom of the mask blank 650. The thin absorbing plate then e.g. may be fixed to the top of the mask blank 650, for example by gluing the thin absorbing plate to the mask blank 650.

In a further embodiment, the invention relates to a processing system 500 wherein the method embodiments or part thereof, such as e.g. the evaluation step or part of the evaluation step, according to the present invention are implemented. An exemplary processing system 500 is shown in FIG. 19. FIG. 19 shows one configuration of processing system 500 that includes at least one programmable processor 503 coupled to a memory subsystem 505 that includes at least one form of memory, e.g., RAM, ROM, and so forth. A storage subsystem 507 may be included that has at least one disk drive and/or CD-ROM drive and/or DVD drive. In some implementations, a display system, a keyboard, and a pointing device may be included as part of a user interface subsystem 509 to provide for a user to manually input information. Ports for inputting and outputting data also may be included. More elements such as network connections, interfaces to various devices, and so forth, may be included, but are not illustrated in FIG. 19. The various elements of the processing system 500 may be coupled in various ways, including via a bus subsystem 513 shown in FIG. 19 for simplicity as a single bus, but will be understood to those in the art to include a system of at least one bus. The memory of the memory subsystem 505 may at some time hold part or all (in either case shown as 511) of a set of instructions that when executed on the processing system 500 implement the step(s) of the method embodiments for sub-structuring described herein. Thus, while a processing system 500 such as shown in FIG. 19 is prior art, a system that includes the instructions to implement aspects of the present invention is not prior art, and therefore FIG. 19 is not labeled as prior art.

It is to be noted that the processor 503 or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. Furthermore, aspects of the invention can be implemented in a computer program product tangibly embodied in a carrier medium carrying machine-readable code for execution by a programmable processor. Method steps of aspects of the invention may be performed by a programmable processor executing instructions to perform functions of those aspects of the invention, e.g., by operating on input data and generating output data.

Accordingly, the present invention includes a computer program product which provides the functionality of any of the methods according to the present invention when executed on a computing device. Further, the present invention includes a data carrier such as for example a CD-ROM or a diskette which stores the computer product in a machine-readable form and which executes at least one of the methods of the invention when executed on a computing device. Nowadays, such software is often offered on the Internet or a company Intranet for download, hence the present invention includes transmitting the computer product according to the present invention over a local or wide area network. The computing device may include one of a microprocessor and a micro-controller, for instance a programmable digital logic device such as a Programmable Array Logic (PAL), a Programmable Logic Array, a Programmable Gate Array, especially a Field Programmable Gate Array (FPGA).

It is an advantage of embodiments of the present invention that polarization effects at the mask level can be studied independently from the polarization effects induced by the projection lens. Due to the specific layout of the mask, polarization effects at the mask level are converted to an intensity effect, whereas polarization effects in the projection lens remain polarization effects. Therefore, on the wafer level, i.e. in the image, both polarization effects at the mask and polarization effects induced by the projection lens will have a different “finger prints”. The polarization effects at the mask thus can be evaluated from a change in an image, whereas the polarization effects induced by the lens can be evaluated by evaluating the quality of the image. Therefore, embodiments of the present invention not only allow independent evaluation of the polarization effects at the mask level, but also allow to simultaneously evaluate the polarization effects induced by the projection lens.

It is also an advantage of embodiments of the present invention that they can be used for matching the polarization state of illumination systems in different optical systems. The latter can be performed by performing the method for evaluating the polarization state for all different optical systems and by adjusting these systems until, within a predetermined accuracy level, the polarization state of the illumination systems is matched for these systems.

Other arrangements for accomplishing the objectives of the methods and systems for evaluating the polarization degree of an illumination system embodying the invention will be obvious for those skilled in the art.

It is to be understood that although preferred embodiments, specific constructions and configurations, as well as materials, have been discussed herein for devices according to the present invention, various changes or modifications in form and detail may be made without departing from the scope and spirit of this invention.

1. A method (200) for evaluating an illumination system (52) in an optical system (50), the method comprising:
providing (202) a mask (56) in said optical system (50), the mask (56) being adapted so as to diffract in a substantially different way incident components of an illumination beam having a different polarization state,
obtaining (204) an image of said mask (56) using an illumination beam of said illumination system (52) incident on said mask (56), and
evaluating (206) said image to extract polarization related information about said illumination system (52).

2. A method (200) according to claim 1, wherein the mask being adapted so as to diffract in a substantially different way incident components of an illumination beam having a different polarization state comprises the mask being adapted so as to generate in a substantially different way zero and first order diffraction beams for incident components of an illumination beam having a different polarization state.

3. A method (200) according to claim 1, wherein diffracting in a substantially different way incident components of an illumination beam having a different polarization state comprises differently suppressing a zero order diffraction beam of said components.

4. A method (200) according to claim 1, wherein said evaluating (206) comprises obtaining a degree of polarization for said illumination system (52).

5. A method (200) according to claim 1, wherein said evaluating (206) comprises comparing light intensities in an image plane.

6. A method (200) according to claim 1, said image comprising at least one feature, wherein said evaluating (206) said image comprises extracting feature sizes from said image.

7. A method (200) according to claim 1, said image comprising a plurality of features, wherein said evaluating (206) said image comprises extracting intensity differences between neighboring features.

8. A method (200) according to claim 1, λ being the average wavelength of the illumination beam of the illumination system (52) and said mask (56) comprising a pattern with features characterized by an average feature size, wherein said mask (56) is adapted by selecting an average feature size to be in a range between 0.2λ and 4λ, preferably between λ and 3λ.

9. A method (200) according to claim 1, λ being the average wavelength of the illumination beam of the illumination system (52) and said mask (56) comprising a pattern with features characterized by an average pitch size, wherein said mask (56) is adapted by selecting an average pitch size to be in a range between 0.2λ and 6λ, preferably between λ and 5λ.

10. A method (200) according to claim 1, wherein said mask (56) comprises a pattern with a plurality of features in order to obtain a confined diffraction of said illumination beam.

11. A method (200) according to claim 1, wherein said mask comprises a plurality of areas having a first feature density separated by areas with a second feature density, the first feature density being different from the second feature density.

12. A method (200) according to claim 1, wherein said obtaining (204) an image of said mask (56) comprises illuminating a resist layer with a pattern of the mask (56) or a negative image thereof and developing said resist layer.

13. A method (200) according to claim 1, wherein said obtaining (204) an image of said mask (56) comprises measuring the light intensity in an image plane for said illumination beam.

14. A method (200) according to claim 1, wherein obtaining an image of said mask (56) comprises obtaining a diffraction image of the mask (56).

15. A method (200) according to claim 1, wherein evaluating said image comprises evaluating a predetermined diffraction order in the diffraction image (56).

16. A method (200) according to claim 15, wherein evaluating the predetermined diffraction order in the diffraction image comprises evaluating a parameter of the predetermined diffraction order as function of an orientation of a test pattern provided on the mask (56).

17. A method (200) according to claim 1, wherein obtaining an image of said mask using an illumination beam of said illumination system (52) incident on said mask (56) comprises blocking at least part of an illumination of said illumination system (52), such that said illumination beam is equivalent to an illumination beam of a monopole or dipole illumination system.

18. A method (200) according to claim 17, wherein providing a mask furthermore comprises providing a filter (652) for blocking at least part of an illumination of said illumination system (52).

19. A method (200) according to claim 12, wherein evaluating said image to extract polarization related information about said illumination system (52) comprises evaluating dose-to-clear information.

20. An optical system, the optical system comprising an illumination system (52) and a detector, whereby said detector is adapted for being positioned at an image plane of the optical system and furthermore is adapted for recording an image of a mask (56) diffracting in a substantially different way incident components of a light beam having a different polarization state, the optical system furthermore comprising a computing means for evaluating said image to extract polarization related information about said illumination system (52).

21. An optical system according to claim 20, said optical system furthermore comprising a substrate stage, whereby said detector is incorporated in said substrate stage.

22. An optical system according to claim 20, said optical system furthermore comprising a processed wafer, whereby said detector is incorporated in said processed wafer.

23. A computer program product for executing a method for evaluating an illumination system (52) in an optical system (50) according to claim 1.

24. A machine readable data storage device storing a computer program product according to claim 23.
